(19) United States
(12) Patent Application Publication
(10) Pub. No.: US 2008/0075022 A1
(43) Pub. Date: Mar. 27, 2008

(54) Method and System, for Mimo Detection

(76) Inventors: Zhongding Lei, Singapore (SG); Yong-mei Dai, Singapore (SG); Sumei Sun, Singapore (SG)

Correspondence Address: CROCKETT & CROCKETT, 24012 CALLE DE LA PLATA, SUITE 400, LAGUNA HILLS, CA, 92653, US

(21) Appl. No.: 11/576,306

(22) PCT Filed: Sep. 15, 2005
(86) PCT No.: PCT/SG05/00315

§ 371 Date: Dec. 3, 2007

Related U.S. Application Data
(60) Provisional application No. 60/615,160, filed on Oct. 1, 2004.

(51) Int. Cl. H04B 7/00; H04Q 7/00

(52) U.S. Cl. 370/310

(57) ABSTRACT

A method for determining a signal vector comprising a plurality of components from a received signal vector is described, wherein a component of the plurality of components is selected and for each candidate symbol of a list of candidate symbols, wherein each candidate symbol represents a possible symbol for the selected component, a candidate signal vector for the candidate symbol is generated under the assumption that the selected component is equal to the candidate symbol. The signal vector is determined based on a quality measure of the candidate signal vectors.

### FIELD OF THE INVENTION

The invention relates to a method for determining a signal vector, a system for determining a signal vector and a computer program element.

### BACKGROUND OF THE INVENTION

Recent research in information theory has shown that the wireless channel capacity in a MIMO (multiple input multiple output) communication system can be increased linearly with the number of transceiver antennas. The great potential for achieving high data rate in wireless communications by exploring the spatial domain using multiple antennas has been attracting more and more attention in the business and scientific communities.

The IEEE 802.11 wireless local area network (WLAN) working group has set up the task group 802.11n for standardization of higher throughput enhancements of 802.11 by using MIMO technologies. It is supposed to provide more than 100 Mbps (e.g. 320 Mbps with 20 MHz bandwidth) data rate transmission in a WLAN system. In fact, MIMO techniques are also considered as promising for other standards, such as the IEEE 802.16 WiMax (worldwide interoperability for microwave access) for high data rate broadband wireless access (BWA), the IEEE 802.20 and 3 GPP HSDPA (high speed downlink packet access) for high data rate cellular systems, and the WiMedia Alliance/1394 Trade Association for very high data rate wireless personal area networks (WPANs) with probably more than 1 Gbps transmission rate.

In theory, the great channel capacity promised by MIMO systems is fully achievable only by using the optimal maximum likelihood (ML) detection at the receiver. However, the major problem associated with such a nonlinear receiver is its computational complexity, which increases exponentially with the number of antennas at the transmitter and the receiver and the size of the modulation constellations.

Recently, the sphere detector has been introduced to MIMO systems. The lure of the sphere decoder is that its expected (or average) complexity is polynomial (see [1]). Unfortunately, the so-called expected polynomial complexity is only given in some special cases, whereas in general, the sphere detector still has exponential average complexity. Apart from this, the maximum complexity of the sphere detector is much larger than its average complexity. For a practical system design, a limitation of the maximum complexity is desirable. However, a sphere detector with limited maximum complexity is no exact implementation of maximum likelihood detection. Therefore, suboptimal detection schemes have to be used in practical MIMO systems.

A considerable amount of research has been conducted in order to find less complex algorithms or structures to exploit as much as possible the transmission capacity provided by MIMO channels. Among them, the most popular architecture is the Bell Labs Layered Space-Time architecture (BLAST), including the most practical version so far, the vertical BLAST (V-BLAST, see [2]). According to V-BLAST, the information data stream to be transmitted is first de-multiplexed to a plurality of sub-streams, which are transmitted by different transmit antennas via a multipath channel. At the receiver, the signals received at multiple receive antennas are detected iteratively and the detection order of de-multiplexed sub-streams is optimized from a performance point of view.

It is demonstrated that V-BLAST provides cost-effectiveness and high spectral efficiency and that by using V-BLAST nearly 60% of the channel capacity can be reached. The complexity of V-BLAST is varied using different detection algorithms (see [3], [4], [5]). Essentially, it is much lower than that of maximum likelihood detection and in the order of cubic complexity or less in respect of the number of transceiver antennas.

The performance of the conventional V-BLAST algorithms is, as expected, far from maximum likelihood detection performance. In light of this, the so-called QRD-M algorithm, proposed originally for CDMA (code division multiple access) multi-user detection, has been introduced recently to MIMO systems (see [6]). QRD-M detection reduces the computational cost by combining QR-decomposition and ordered detection with the well known M-algorithm in the coding theory to simplify the tree searching process. The performance achieved by QRD-M is comparable to that of maximum likelihood detection, especially when the number of antennas and the number of modulation constellations are relatively low.

The trade-off between performance and complexity of QRD-M can be adjusted through setting of the parameter M, which is the tree searching size in each step. However, to achieve near optimal maximum likelihood performance for QRD-M, a larger value of M needs to be used. In this case, the computational complexity of QRD-M is still very high. When its complexity is limited to be comparable to conventional V-BLAST detection, the performance of QRD-M degrades quickly. In other words, QRD-M is not very efficient in achieving near optimal maximum likelihood performance. Therefore, there is clearly a need to improve the MIMO system performance with moderate complexity.

In the following, a mathematical formulation of some detection methods usable according to V-BLAST is given, in particular of the QRD-M detection mentioned above.

Let a MIMO system according to the V-BLAST architecture comprise Nₜ transmit antennas and Nᵣ receive antennas. When the transmit antennas transmit a signal vector d=[d₁,d₂, . . . ,d_{N}_{ₜ}]^{T}, of which each component is transmitted by one transmit antenna and all components are transmitted simultaneously, the received signal vector r=[r₁,r₂, . . . ,r_{N}_{ᵣ}]^{T} (each component is received by one receive antenna) can be written as

r=H·d+v (1)

where H is the Nᵣ×Nₜ complex channel matrix with statistically independent entries and v is the complex Gaussian noise vector with zero mean and variance σᵥ².

A linear detection is simply to multiply the received signal vector r with a linear transform matrix G, i.e., the estimated signal vector \hat{d} can be represented as

\hat{d}=G·r=G·H·d+G·v. (2)

This linear processing is also known as “nulling”. Because the effect of the linear processing for each sub-stream is to keep the desired sub-stream signal while suppress or “null” the other sub-stream signals at the same time.

The linear detection algorithms differ from each other by the selection of G, which can be derived based on different criterion. The most common linear detection algorithms are zero forcing (ZF) and minimum mean squared error (MMSE) for which the corresponding linear transform matrix are

G=H⁺ (3)

and

G=P·H^{H} (4)

respectively, where P=(H^{H}·H+σᵥ²·I_{M})⁻¹ and the superscript ‘+’ represents matrix pseudo inverse, superscript ‘H’ represents Hermitian and superscript ‘−1’ represents matrix inverse. As can be seen, by the linear detection, estimates for all Nₜ components of d are obtained at the same time.

The interference cancellation (IC) detection comes from multi-user detection. According to this kind of detection method, not all Nₜ components of the transmitted signal vector are detected at one go. Instead, it starts with linear detection of only one sub-stream by means of nulling with ZF or MMSE for example, i.e., by multiplying r with a row vector of the linear transform matrix G instead of the whole matrix G. The sub-stream (i.e. component of signal vector) detected first is the one corresponding to the highest post-detection signal-to-noise ratio (SNR). Then the effect of the detected sub-stream is subtracted out from the received signal vector, resulting in a modified received vector with less “interferers”, i.e. sub-streams that give rise to interference. This process proceeds until all the sub-streams are detected.

Let the ordered set ←={k₁,k₂, . . . ,k_{N}_{ₜ}} be a permutation of the integers 1, 2, . . . , Nₜ specifying the order in which components of the transmitted signal vector d are extracted. The full detection algorithm with ZF nulling can be described compactly as a recursive procedure, including determination of the optimal ordering, as follows:

a) initialization: i ←1

G₁=H⁺ (5a)

k₁=argⱼmin ∥(G₁)ⱼ∥² (5b)

b) recursion

$$\begin{matrix}{\underline{w}}_{{k}_{i}} = {[ {( {\underline{G}}_{i} )}_{{k}_{i}} ]}^{T} & ( 5 c ) \\ {y}_{{k}_{i}} = {\underline{w}}_{{k}_{i}}^{T} \cdot {\underline{r}}_{i} ( {\underline{r}}_{i} = \underline{r} ) & ( 5 d ) \\ {\hat{d}}_{{k}_{i}} = Q ( {y}_{{k}_{i}} ) & ( 5 e ) \\ {\underline{r}}_{i + 1} = {\underline{r}}_{i} - {\hat{d}}_{{k}_{i}} \cdot {( \underline{H} )}_{{k}_{i}} & ( 5 f ) \\ {\underline{G}}_{i + 1} = {\underline{H}}_{{k}_{i}}^{\pm } & ( 5 g ) \\ {k}_{i + 1} = {arg min}_{j ∉ \{ {k}_{1} , … , {k}_{i} \}} {‖ {\underline{G}}_{i + 1} )}_{j} {\text{‖}}^{2} & ( 5 h ) \\ i ← i + 1 & ( 5 i )\end{matrix}$$

where (.)ⱼ denotes the jth column of the matrix within the bracket, H _{k̅}_{ᵢ} stands for the matrix obtained by zeroing the columns k₁, k₂, . . . , kᵢ of H, ∥.∥ denotes length of vector and Q(.) denotes the quantization (slicing) operation appropriate to the constellation in use.

For IC detection with MMSE, the steps are similar except that Gᵢ (i=1, . . . , Nₜ ) are calculated based on the formula (4) instead of (3) and an ordering is determined based on matrix P instead of G as in steps (5b) and (5h).

As mentioned above, the QRD-M algorithm is a variant of the well known M-algorithm or the breadth-first detection algorithm. Essentially, it puts an upper limit on the number of searching branches during the tree searching process based on the maximum likelihood cost function.

The maximum likelihood estimate of the transmitted vector d is the solution of the following minimization problem:

\hat{d}=arg min ∥r−H·d∥² (6)

where ∥.∥ stands for the vector norm.

Instead of the brute force searching for the solution of (6) as in the maximum likelihood detection, the QRD-M algorithm utilizes QR-decomposition to get a modified minimization problem.

$$\hat{\underline{d}} = arg min {‖ {\underline{r}}^{′} - {\underline{Q}}^{H} \cdot \underline{H} \cdot \underline{d} ‖}^{2} \\ where \\ {\underline{r}}^{′} = {\underline{Q}}^{H} \cdot \underline{r} \\ {\underline{Q}}^{H} \cdot \underline{Q} = \underline{I} \\ \underline{Q} \cdot [ \begin{matrix}{\underline{R}}_{{N}_{t} {xN}_{t}} \\ {\underline{0}}_{( {N}_{r} - {N}_{t} ) {xN}_{t}}\end{matrix} ] = \underline{H} \qquad ( 7 )$$

Note that the channel matrix H in (7) is in fact a permutation of the original channel matrix. It is re-arranged so that the column norm is in increasing order.

Since the matrix R is an upper triangular matrix, decisions can be made from the strongest data to the weakest data sequentially by removing stronger data from the received signal in each step. The best solution for equation (7) is applying the optimal tree searching technique, which requires searching through S^{N}^{ₜ} branches (S denotes the constellation size). However, the computational cost grows exponentially with the value of Nₜ . Combining with the M-algorithm, each survivor path is extended and only M branches with minimum accumulated distance metrics are retained at each level of the tree. Thus, this QRD-M algorithm is a suboptimal tree searching algorithm but with lower computational cost compared to maximum likelihood detection. As M goes to S^{N}^{ₜ}, the detection performance approaches the maximum likelihood detection performance.

### SUMMARY OF THE INVENTION

The object is achieved by a method for determining a signal vector, a system for determining a signal vector and a computer program element with the features according to the independent claims.

A method for determining a signal vector comprising a plurality of components from a received signal vector is provided wherein a component of the plurality of components is selected, and wherein for each candidate symbol of a list of candidate symbols, wherein each candidate symbol represents a possible symbol for the selected component, a candidate signal vector for the candidate symbol is generated under the assumption that the selected component is equal to the candidate symbol. The signal vector is determined from the candidate signal vectors based on a quality measure of the candidate signal vectors.

Further, a system for determining a signal vector and a computer program element according to the method for determining a signal vector described above are provided.

### SHORT DESCRIPTION OF THE FIGURES

Illustrative embodiments of the invention are explained below with reference to the drawings.

FIG. 1 shows a communication system according to an embodiment of the invention.

FIG. 2 shows a flow diagram according to an embodiment of the invention.

FIG. 3 shows simulation results according to an embodiment of the invention.

FIG. 4 shows simulation results according to an embodiment of the invention.

FIG. 5 shows simulation results according to an embodiment of the invention.

FIG. 6 shows simulation results according to an embodiment of the invention.

### DETAILED DESCRIPTION

Illustratively, a list of possible symbols for the selected component is used. The list exists for example of a set of constellation symbols that are possible for the selected component. For each of the elements of the list, it is assumed that the selected component actually equals the element and under this assumption, the remaining components are generated. For example, when it is assumed that the selected component equals a certain element of the list, the interference that this element would cause if it was equal to the selected component is cancelled from the remaining components of the received signal vector and the remaining components of the signal vector are determined. The different candidate signal vectors generated based on the assumptions that the selected component equals the elements of the list are compared using some quality measure and the best one is chosen as the signal vector to be determined.

Near optimal maximum likelihood detection performance can be achieved. The invention is especially efficient in and can for example be applied to high data rate packet transmission systems such as WLAN (wireless local area network) based hotspots, fixed broadband wireless access systems, 4G cellular based hotspots, WPANs (wireless personal area networks) etc. The computational complexity of the invention is, for example in one embodiment described below, significantly lower than that of maximum likelihood detection and the state of the art technologies.

Embodiments of the invention emerge from the dependent claims. The embodiments which are described in the context of the method for determining a signal vector are analogously valid for the system for determining a signal vector and the computer program element.

The received signal vector can be a radio signal vector received via at least one antenna. For example, the received signal vector is a radio signal vector received via a MIMO system.

A candidate signal vector for a candidate symbol may be determined by setting the selected component to the candidate symbol and determining the remaining components.

In one embodiment, the remaining components are determined by IC detection. The remaining components by also be determined by linear detection or by another conventional detection.

For example, the component of the plurality of components is selected that has the lowest quality in the received signal vector. For example, the component of the plurality of components is selected that has the lowest quality in the received signal vector in terms of post SNR or largest mean square error.

The signal vector is for example determined from the candidate signal vectors by determining a metric of the candidate signal vectors and choosing the candidate signal vector with the best metric.

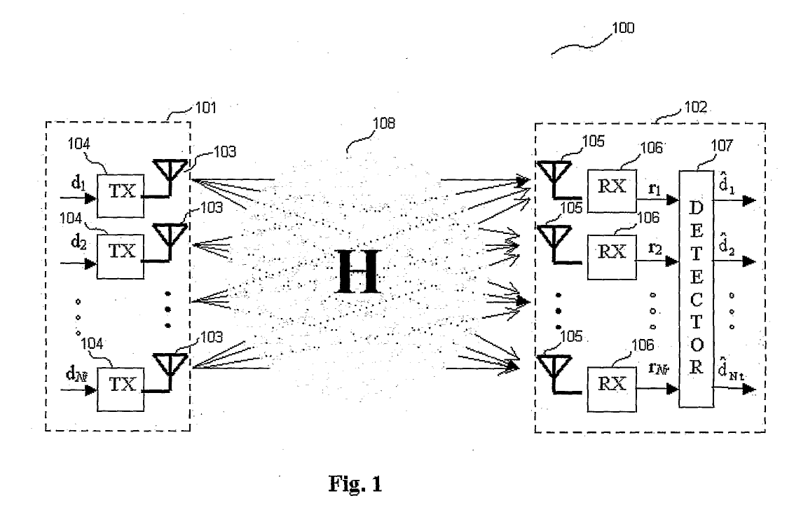

FIG. 1 shows a communication system 100 according to an embodiment of the invention.

The communication system 100 comprises a transmitter 101 and a receiver 102. The transmitter 101 comprises a plurality of transmit antennas 103, each transmit antenna 103 being coupled with a respective sending unit 104.

Each sending unit 104 is supplied with a component of a signal vector d=[d₁,d₂, . . . ,d_{N}_{ₜ}]^{T} where Nₜ is the number of transmit antennas 103. Each sending unit 104 transmits the respective component of the signal vector d using the respective antenna 103, such that altogether, the signal vector d is sent. The transmitted signal vector is received by the transmitter 102 by a plurality of receive antennas 105, each receive antenna 105 being coupled with a respective receiving unit 106, in form of the received signal vector r=[r₁,r₂, . . . , r_{N}_{ᵣ}]^{T} via a communication channel 108. Nᵣ denotes the number of receive antennas 105, wherein Nₜ≦Nᵣ.

Since Nᵣ and Nₜ are bigger than one, the communication system 100 is a MIMO (multiple input multiple output) system, for example a MIMO-OFDM (orthogonal frequency division multiplexing) system with Nₜ=Nᵣ=4 or 8 and working at a center frequency of 5 GHz with a system bandwidth of 20 MHz.

Each receive antenna 105 receives one component of the received signal vector r and the respective component is output by the receiving unit 106 coupled to the antenna and fed to a detector 107.

The transmission characteristics of the communication channel 108 between the transmit antennas 103 and the receive antennas 105 can be modelled by a complex channel matrix H.

The received signal vector r can be written as

r=H·d+v (8)

where v is the complex Gaussian noise vector with zero mean and variance σᵥ².

communication system 100 is in one embodiment formed according to the V-BLAST architecture. The signal vector d is generated from a single data stream that is de-multiplexed in the transmitter 101 into Nₜ sub-streams. Each sub-stream is encoded into symbols and one symbol of a sub-stream corresponds to a component of the signal vector d.

communication channel 108 is a rich-scattering multipath channel and is assumed to be fading slowly relative to the signaling such that the attenuation experienced by one or a few package data is invariant. This assumption is valid for many systems. For example, the transceivers are fixed in BWA (broadband wireless access) systems and the mobility in WPAN (wireless personal area networks) systems is minimal, hence the Doppler spread is expected to be very small. For WLAN (wireless local area networks) and cellular systems, MIMO techniques are typically designed for those “good channels” with limited mobility to achieve peak data rate transmission. For higher mobility situations, other multiple antenna technologies like beamforming and selection diversity can be used.

The fadings between the antenna pairs (one pair consisting of one transmit antenna 103 and one receive antenna 105) are assumed to be independent. However, the embodiment can be extended directly to correlated MIMO channels with some performance degradation. Anyway, it will introduce a trivial effect on the relative performance between different detection schemes.

The communication channel 108 is further assumed to be flat fading for simplicity. However, the embodiment is also extendable to a frequency-selective fading channel in an OFDM system, as it is described in [4] and [6].

The detector 107 uses the received signal vector r to generate an estimated signal vector \hat{d} which is an estimate for the originally sent signal vector d.

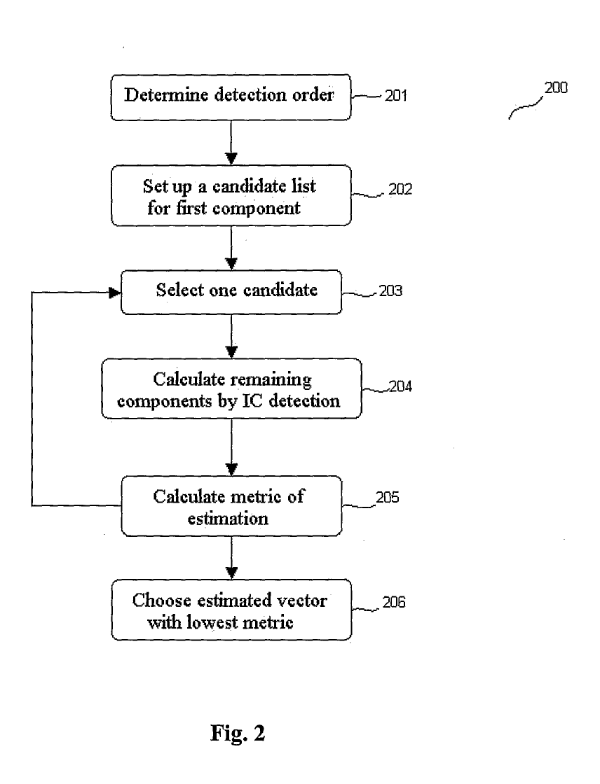

The functionality of the detector 107 is explained in the following with reference to FIG. 2. The detection method carried out by the detector 107 is referred to as list detection.

FIG. 2 shows a flow diagram 200 according to an embodiment of the invention.

In step 201 a detection order of sub-streams is determined. This means that an ordered set ç={k₁,k₂, . . . ,k_{N}_{ₜ}} is determined, that is a permutation of the integers 1, 2, . . . , Nₜ and specifies the order in which the components of the detected signal vector \hat{d} are determined.

Similar to the conventional IC (interference cancellation) detection, the detection order of sub-streams can be determined using the channel matrix H. It should be noted, however, that the optimal order for the list detection carried out by the detector 107 is different from the optimal order in conventional IC detection. This is because the first detected sub-stream in the list detection is no longer the most vulnerable sub-stream, which is true in conventional IC detection. In fact, the first detected sub-stream will be the maximum likelihood detection with full diversity order achieved and thus the most reliable one, irrespective of the channel conditions.

Therefore, the first sub-stream to be detected (corresponding to k₁ in the set ç) should be selected such that it is corresponding to the “worst” sub-channel in the conventional IC detection to save the better sub-channels to be used in later detection, where the conventional IC is employed. After detection of the first sub-stream, the detection order for the remaining sub-streams can be determined in the same way as in the conventional IC detection.

The ordering step 201 can be summarized as follows:
Identify the worst sub-stream as the first sub-stream to be detected, in terms of having least post SNR or largest MSE (mean square error) by using conventional IC ordering techniques, such as using pseudo-inverse of H or square-root techniques, see [5].
Continue to identify the best sub-stream in the remaining sub-streams one by one iteratively, as in the conventional IC detection.

When the detection order is determined, a candidate list for the first sub-stream, i.e. the first component to be detected according to the index k₁ is set up in step 202. This means that a list of possible symbols for the component \hat{d}ₖ_{₁} is generated. For example, all signal constellations may be included in the candidate list such that the size of the candidate list is equal to the constellation size S. The constellation size S depends on the modulation used for generation of the symbols forming the signal vector d. In case of QAM modulation, S depends on whether 16-QAM, 64-QAM etc. is used.

In step 203, a candidate from the candidate list is selected (starting from a first candidate, according to an arbitrary ordering of the candidate list). Illustratively, a hypothesis is made that the selected candidate is the first component (corresponding to k₁) of the transmitted signal vector d.

In step 204, using the selected candidate as the first component of \hat{d}, all remaining components of \hat{d} successively determined.

This can be done similar to conventional IC detection, for example according to the equations

$$\begin{matrix}{\underline{w}}_{{k}_{i}} = {[ {( {\underline{G}}_{i} )}_{{k}_{i}} ]}^{T} & ( 9 ) \\ {y}_{{k}_{i}} = {\underline{w}}_{{k}_{i}}^{T} \cdot {\underline{r}}_{i} ( {\underline{r}}_{1} = \underline{r} ) & ( 10 ) \\ {\hat{d}}_{{k}_{i}} = Q ( {y}_{{k}_{i}} ) & ( 11 ) \\ {\underline{r}}_{i + 1} = {\underline{r}}_{i} - {\hat{d}}_{{k}_{i}} \cdot {( \underline{H} )}_{{k}_{i}} & ( 12 ) \\ {\underline{G}}_{i + 1} = {\underline{H}}_{{k}_{i}}^{\pm } & ( 13 ) \\ {k}_{i + 1} = {arg min}_{j ∉ \{ {k}_{1} , … , {k}_{i} \}} {‖ {\underline{G}}_{i + 1} )}_{j} {\text{‖}}^{2} & ( 14 ) \\ i ← i + 1 & ( 15 )\end{matrix}$$

wherein the equations are carried out iteratively starting with i=1 and ending with i=Nₜ (in each iteration, equations (9) to (15) are processed successively). (.)j denotes the jth column of the matrix within the bracket, H _{k̅}_{ᵢ} stands for the matrix obtained by zeroing the columns k₁, k₂, . . . , kᵢ of H, ∥.∥ denotes length of vector and Q(.) denotes the quantization (slicing) operation appropriate to the constellation in use.

The matrix G is a linear transform matrix and is initizialized by

G₁=H⁺. (16)

The result of step 204 is thus an estimated signal vector \hat{d}, the first (corresponding to k₁) component of which is the first candidate from the list.

Based on this estimation of the signal vector, the quality of the first candidate is evaluated using a metric in step 205. The metric is in this embodiment based on the maximum likelihood detection cost function and is given by

Λ=∥r−H·\hat{d}∥² (17)

where \hat{d}, as mentioned, is the estimated signal vector based on the first candidate.

The processing returns to step 203, in which another candidate is selected and an estimated signal vector \hat{d} is calculated based on this candidate, i.e. the candidate is used as the first component of \hat{d} and the remaining components are calculated based on the first component as described above. Then, the metric of the vector \hat{d} is calculated to according to equation (17).

The steps 203 to 205 are repeated for all candidates in the candidate list. The result is a plurality of estimated signal vectors \hat{d}, each based on one candidate from the candidate list. As the estimated signal vector \hat{d} that is output by the detector 107, the one with the lowest metric according to equation (17) is chosen in step 206. All others are discarded.

This can be done successively, i.e. when two estimated signal vectors \hat{d} have been calculated according to two candidates, the metrics may be compared and the estimated signal vector corresponding to the higher metric and the candidate on which it is based are discarded. This may be done until only one candidate is left.

From the detailed steps of the list detection described with reference to FIG. 2, it can be seen that the estimation of the first sub-stream (first component corresponding to k₁) is from the hypothesis, i.e. from the candidate currently selected. Under error free assumption for each sub-stream as n IC detection, the diversity orders achieved for all sub-streams are Nₜ, Nᵣ−Nₜ+2, . . . , Nₜ, respectively. Compared with conventional IC detection, the most vulnerable first sub-stream that might cause significant errors now becomes the most reliable one with the same diversity order as the maximum likelihood detection. With the reliable estimation of the first detection, the IC detection for remaining sub-streams starts with diversity order Nᵣ−Nₜ+2, one more order than conventional IC detection. Both effects of enlarged diversity order and less possible error propagation boost the performance of the conventional IC detection significantly. As can be seen from simulations, the performance of the list detection approaches well that of maximum likelihood detection and shows higher diversity order that that of QRD-M detection.

The complexity of the list detection is dependent on the candidate list size. In general it is roughly equal to the complexity of the IC detection multiplied with the candidate list size and is much lower that that of QRD-M. Specifically, the complexity in terms of the required number of complex multiplications and additions in one signal vector for the list detection and QRD-M detection can be calculated as shown in table 1.

TABLE 1

| | IC | QRD-M | list detection |
|---|---|---|---|
| number of | 2Nₜ · Nᵣ − Nᵣ | M² · (Nₜ² + 3Nₜ − 4)/ | S · (2Nₜ · |
| required | | 2 + 2M + (Nᵣ² + Nᵣ − Nₜ) | Nᵣ + 1) |
| multiplications | | | |
| number of | 2Nₜ · Nᵣ − | M² · (Nₜ² + Nₜ − 2)/ | S · (2Nₜ · Nᵣ − |
| required | Nₜ − Nᵣ | 2 + M + (Nᵣ² − 1) | Nₜ + 1) |
| additions | | | |

It should be noted that the channel matrix H in a slow fading or quasi static channel can be assumed to be constant for one or a few packages, typically with hundreds to thousands of symbols. The manipulations on the channel itself, such as QR-decomposition and/or inversion etc., can be performed only once per package and do not incur much complexity surplus compared with the metric calculation and nulling process working in the symbol rate. Therefore, the manipulations on the channel itself are not counted in table 1.

When example values are used, the terms given in table 1 show that the complexity of the list detection as described above is much lower than the complexity of QRD-M. For example, when 16-QAM is used, the complexity of QRD-M detection is more than five times than that of the list detection (for a medium to large number of transmit antennas and receive antennas). It can be derived from the terms given in table 1 that, if S equals M, the complexity of the list detection is one order less (O(S²)) than that of QRD-M (O(S³)). Therefore, list detection has a clear advantage concerning complexity when the constellation size is large, such as in case of 64-QAM modulation.

For different purposes, variants of the list detection described above may be used.

If the complexity is of big concern in case of a large constellation size S, such as in case of 64-QAM modulation or even 256-QAM modulation, a smaller candidate list can be used by using some pre-processing techniques. For example, linear detection or one round of conventional IC detection can be performed as an initial stage of detection. After the conventional detection, one of the detected sub-streams can be selected as the first sub-stream to be detected in the next stage based on certain criteria. The candidate list can be set as the set including only the adjacent points to the constellation estimated for this first sub-stream to be detected during the initial stage. List detection can then be performed based on this candidate list which is smaller than the one comprising all possible constellation symbols. However, the performance of the detection will typically be not as good as in the embodiment described above.

For applications where many transmit antennas and receive antennas are employed, another variant can be used. If the complexity constraint is not stringent, the size of the candidate list can be increased especially in case of small constellation size, such as in case of QPSK (quadrature phase shift keying) and BPSK (binary phase shift keying). In this case, the candidate list may not be limited to contain only one dimension of constellations, that is the possible constellation symbols for the first sub-stream to be detected. The candidate list may contain two or more dimensions of constellation symbols, that is pairs of constellation symbols or vectors of constellation symbols wherein each component corresponds to a sub-stream to be detected. For example, for the first two sub-streams to be detected, all pairs consisting of a possible constellation symbol for the first sub-stream and a possible constellation symbol for the second sub-stream may be contained in the candidate list and list detection will be performed based on this candidate list, where hypothesis for the first two sub-streams are used. Analogously, triples and vectors with higher dimensions may be used for the candidate list. This will increase the complexity of the list detection, but performance in terms of accuracy can be increased in this way.

Table 2 gives a comparison of IC detection and the list detection of one embodiment.

TABLE 2

| Interference Cancellation | |
|---|---|
| Detection | List Detection |
| 1. Receive Nₜ transmitted | 1. Receive Nₜ transmitted |
| signals at a time at the | signals at a time at the |
| receiver with Nᵣ receive | receiver with Nᵣ receive |
| antennas. | antennas. |
| 2. Identify the strongest | 2. Set up a candidate list |
| signal, in terms of the post- | (typically the candidate list |
| detection SNR, amongst the Nₜ | size is the same as the |
| signals. | constellation size of the |
| 3. Detect the strongest | transmitted signals). |
| signal. | 3. Identify the weakest |
| 4. Cancel the effect of the | signal, in terms of post- |
| detected signal from the | detection SNR amongst the Nₜ |
| received signals. | signals. |
| 5. Identify the next strongest | 4. Randomly select one |
| signal. | candidate from the list in |
| 6. Detect the identified | step 2. |
| signal. | 5. Make a hypothesis that the |
| 7. Cancel the effect of all | candidate is the weakest |
| detected signals from the | transmitted signal identified |
| received signals. | in step 3. |
| 8. Repeat 5 until all signals | 6. Cancel the effect of the |
| are detected. | candidate signal from the |
| | received signals. |
| | 7. Identify the next strongest |
| | signal. |
| | 8. Detect the identified |
| | signal. |
| | 9. Cancel the effect of the |
| | detected signal from the |
| | received signals. |
| | 10. Repeat 5 until all signals |
| | are detected. |
| | 11. Calculate a metric for all |
| | the detected signals due to |
| | the hypothesis made in step 5. |
| | 12. Compare the calculated |
| | metric with the previous |
| | (saved) calculated metric (the |
| | initial metric may be set to |
| | positive infinity/the |
| | largest number). |
| | 13. If the calculated metric |
| | is smaller, save the metric |
| | and keep the candidate in the |
| | list. |
| | Otherwise, discard the metric |
| | and delete the candidate from |
| | the list. |
| | 14. Select another candidate |
| | from the list and repeat 5 |
| | until only one candidate is |
| | left in the list. |
| | 15. Output the remaining |
| | candidate together with the |
| | detected signals based on the |
| | candidate in 10 as the final |
| | detection |

Simulations show that the list detection improves the IC detection, IC-MMSE and IC-ZF, significantly in terms of BER (bit error rate). In case of a frequency selective fading channel, the performance of the list detection is as least as good as the performance of QRD-M, although, as mentioned above, QRD-M has a much higher complexity.

It can be seen that QRD-M needs larger M, hence exponentially increased computational cost to approach maximum likelihood performance. For smaller M with lower complexity the performance improvement over conventional detection might not be significant.

The list detection algorithm can be considered as a combination of a conventional algorithm, such as IC detection, with maximum likelihood detection without explicit tree searching. IC detection has much better performance than linear detection. However, the performance gap between IC detection and maximum likelihood detection is still very large. This is because the first detected sub-streams in IC detection are vulnerable. From the steps of IC detection, it can be seen that IC detection can achieve diversity order of Nᵣ −Nₜ+1, Nᵣ−Nₜ+2, . . . , Nᵣ, for the detected sub-streams 1, 2, . . . , Nₜ respectively, with the decision error free assumption in each iteration, whereas the maximum likelihood detection achieves diversity order of Nᵣ for all detected sub-streams. In other words, the two bottlenecks for IC detection, as opposed for maximum likelihood detection, are lower diversity orders for the first detected sub-streams and error propagation problems due to wrong decisions of the sub-streams. The problems become even more severe when the numbers of transmit and receive antennas are the same. In this case, IC detection will achieve only one order of diversity (same as linear detection) for the first detected sub-stream as opposed to Nᵣ for maximum likelihood detection. Further, the error prone detection of the first detected sub-stream is used for the detection of all other sub-streams which might cause catastrophic errors once the first detection is incorrect. Therefore, one of the main aims of this proposed list detection is to tackle the problem of the two bottlenecks for IC detection.

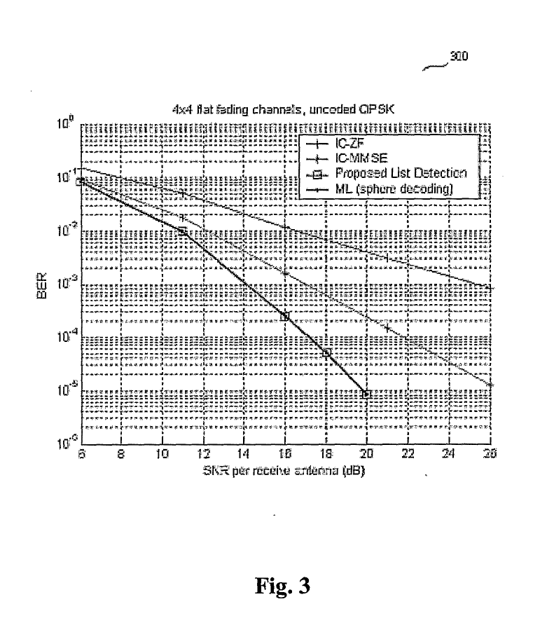

FIG. 3 shows simulation results 300 according to an embodiment of the invention.

The simulation results 300 shown in FIG. 3 are the results of simulations that have been performed for a flat fading channel. In the simulations, the numbers of transmit antennas and receive antennas have been set to 4. The MIMO channel is assumed to be independent Rayleigh fading with additive Gaussian noise. The BER performance of QPSK modulation of the list detection is shown compared to the BER performance of conventional methods, namely ML detection achieved by sphere decoding, IC-MMSE and IC-ZF.

As can be seen, the BER curve of the proposed list detection overlaps with the ML curve exactly. The proposed list detection improves the conventional IC-MMSE and IC-ZF with margins of 3 dB and 14 dB respectively, at BER level of 10⁻³. The margins will be enlarged when SNR increases.

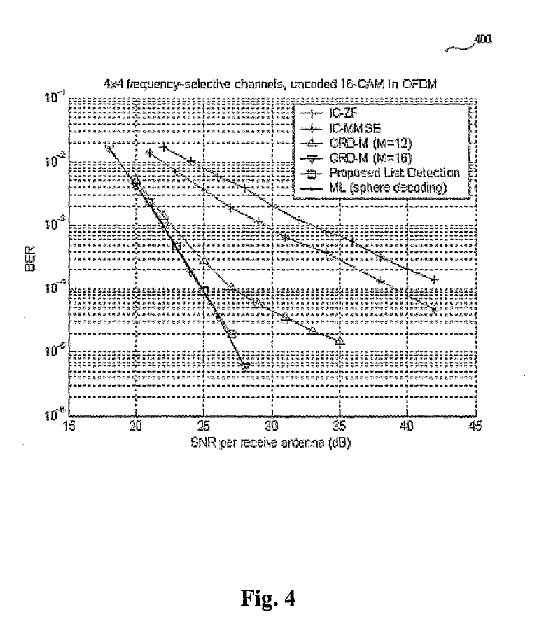

FIG. 4 shows simulation results 400 according to an embodiment of the invention.

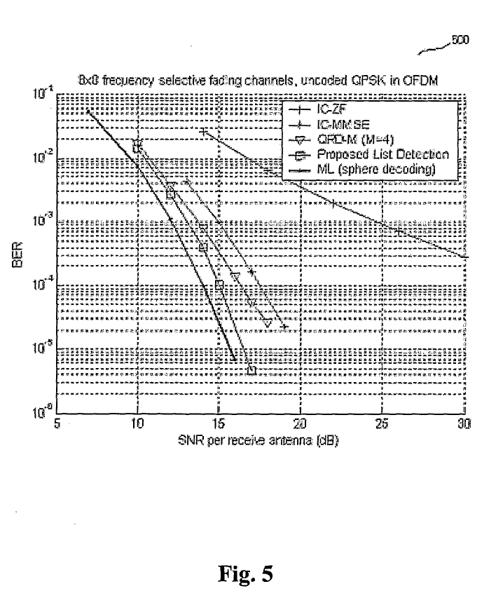

FIG. 5 shows simulation results 500 according to an embodiment of the invention.

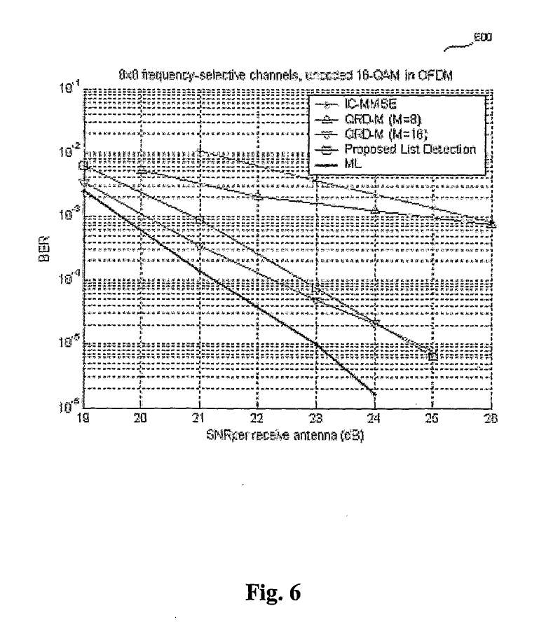

FIG. 6 shows simulation results 600 according to an embodiment of the invention.

The simulation results 400, 500, and 600 are the results of simulations for frequency selective fading channels in a MIMO-OFDM system. Both QPSK and 16-QAM modulation have been considered. The number of transmit and receive antennas were equally set to 4 or 8. Each simulated multipath channel was a 16 tap (sample spaced) slow fading indoor channel and was constant during one packet. The MIMO-OFDM system was working at center frequency 5 GHz with system bandwidth 20 MHz. The number of subcarriers (or FFT size) was 64 with the subcarrier frequency spacing 0.3125 MHz (guard interval 0.8 μs and symbol interval 0.4 μs). The maximum channel delay spread was assumed to be 50 ns.

The BER vs. SNR performance of list detection in a 4×4 MIMO-OFDM system is shown in FIG. 4. For comparison, the performance of IC-ZF, IC-MMSE, QRD-M with different M values and the ML detection achieved by sphere decoding is also included. Similar to FIG. 3, the BER performance of the proposed list detection coincides with that of the ML system. As can be seen, QRD-M when M=16 can also achieve ML performance in this case. However, the complexity of list detection is less than 1/5 of that of QRD-M with M =16 (compare the above remarks concerning complexity with reference to table 1).

The simulation results 500 are the results for simulations for 8×8 transmit and receive antennas with QPSK modulation. It can be seen that list detection achieves better performance than QRD-M with M=4. It exhibits higher diversity order than QRD-M. The performance gap increases with SNR. More importantly, it has at the same time less complexity than QRD-M, as explained above.

The simulation results 600 are the results for simulations for 8×8 transmit and receive antennas with 16-QAM modulation. The BER performance of both QRD-M (M=16) and list detection is approaching ML performance within 1.5 dB. Unlike list detection, the QRD-M begins to show error floor at higher SNR region. Furthermore, QRD-M has more than five times the complexity as list detection.

In this document, the following publications are cited:

[1] B. Hassibi and H. Vikalo “On the expected complexity of integer least-squares problems,” in Proc. IEEE ICASSP'02, vol. 2, pp. 1497-1500, May 2002.

[2] G. D. Golden, G. J. Foschini, R. A. Valenzuela, and P. W. Wolniansky, “Detection algorithm and initial laboratory results using V-BLAST space-time communication architecture”, Electron Lett., vol. 35, pp. 14-16, January 1999

[3] Hufei Zhu. Zhongding Lei, and Francois Chin, “Performance Comparison of Multiple Transmit Multiple-Receive V-BLAST algorithms”, Mobile and wireless communications (Proc. of IFIP Conference on Personal Wireless Communications (PWC'02), Singapore), Kluwer Academic Publishers, pp. 11-17, October 2002

[4] Yan Wu, Sumei Sun, and Zhongding Lei, “Low complexity VBLAST OFDM detection for WLAN”, IEEE Commun. Lett., vol. 8, no. 6, pp. 374-376, June 2004

[5] Hufei Zhu. Zhongding Lei, and Francois Chin, “An improved square-root algorithm for BLAST”, IEEE Signal Processing Lett., no. 9, pp. 772-775, September 2004

[6] Jiang Yue, K. J. Kim, J. D. Gibson, and R. A. Iltis, “Channel estimation and data detection for MIMO-OFDM systems”, in Proc. Globecom'03, vol. 22, no. 1, pp. 581-585, December 2003

1. A Method for determining a signal vector comprising a plurality of components from a received signal vector wherein:
a component of the plurality of components is selected;
for each candidate symbol of a list of candidate symbols, wherein each candidate symbol represents a possible symbol for the selected component, a candidate signal vector for the candidate symbol is generated under the assumption that the selected component is equal to the candidate symbols; and
the signal vector is determined from the candidate signal vectors based on a quality measure of the candidate signal vectors.

2. A method according to claim 1, wherein the received signal vector is a radio signal vector received via at least one antenna.

3. A method according to claim 2, wherein the received signal vector is a radio signal vector received via a MIMO system.

4. A method according to claim 1, wherein a candidate signal vector for a candidate symbol is determined by setting the selected component to the candidate symbol and determining the remaining components.

5. A method according to claim 1, wherein the remaining components are determined by IC detection, linear detection or other conventional detections.

6. A method according claim 1, wherein the component of the plurality of components is selected that has the lowest quality in the received signal vector.

7. A method according claim 1, wherein the component of the plurality of components is selected that has the lowest quality in the received signal vector in terms of post SNR or largest mean square error.

8. A method according claim 1, wherein the signal vector is determined from the candidate signal vectors by determining a metric of the candidate signal vectors and choosing the candidate signal vector with the best metric.

9. A system for determining a signal vector comprising a plurality of components from a received signal vector, the system comprising:
a selection unit adapted to select a component of the plurality of components;
a generation unit adapted for each candidate symbol of a list of candidate symbols, wherein each candidate symbol represents a possible symbol for the selected component, generates a candidate signal vector for the candidate symbol under the assumption that the selected component is equal to the candidate symbol; and
a determination unit adapted to determine the signal vector from the candidate signal vectors based on a quality measure of the candidate signal vectors.

10. A computer program element making a computer perform a method for determining a signal vector comprising a plurality of components from a received signal vector wherein
a component of the plurality of components is selected;
for each candidate symbol of a list of candidate symbols, wherein each candidate symbol represents a possible symbol for the selected component, a candidate signal vector for the candidate symbol is generated under the assumption that the selected component is equal to the candidate symbol; and
the signal vector is determined from the candidate signal vectors based on a quality measure of the candidate signal vectors.
